(19) United States
(12) Patent Application Publication
(10) Pub. No.: US 2025/0265398 A1
(43) Pub. Date: Aug. 21, 2025

(54) MITIGATING EFFECTS OF CYCLIC TIMING PATHS WITHIN A CIRCUIT DESIGN

(71) Applicant: Synopsys, Inc., Sunnyvale, CA (US)

(72) Inventors: Vinod CHANDRASEKARAN, Karnataka (IN); Srivatsan RAGHAVAN, Bangalore (IN); Mikhail BERSHTEYN, Forest Hills, NY (US); Florent DURU, Shrewsbury, MA (US)

(21) Appl. No.: 18/583,757

(22) Filed: Feb. 21, 2024

(51) Int. Cl. G06F 30/3308

(52) U.S. Cl. CPC G06F 30/3308

(57) ABSTRACT

Emulating and verifying a circuit design includes obtaining a circuit design. Further, a first strongly connected component within the circuit design is determined and replica strongly connected components and an output support sub-circuit are generated from the first strongly connected component. The circuit design is updated based on the replica strongly connected components and the output support sub-circuit. The updated circuit design is verified by emulating the updated circuit design.

### TECHNICAL FIELD

The present disclosure relates to determining cyclic timing paths associated with strongly connected components within a circuit design and generating an updated circuit design that is free of cyclic timing paths.

### BACKGROUND

Circuit designs are represented by directed graphs in which primitives (e.g., Boolean function primitives and/or registers, among others) constitute nodes within the graphs and wire segments constitute the edges between the nodes of the graphs. Circuit designs include digital circuits and/or analog circuits. In a synchronous digital circuit, one or more wires are designated as clocks, and the state of the circuit changes contemporaneously with voltage transitions of the clocks (e.g., clock transitions). One or more of the primitives propagate input signal changes to the corresponding outputs without requiring clock transitions and one or more of the primitives propagate input signal changes based on clock transitions, or select ones of the clock transitions.

A timing path of a circuit design is a sequence of connections through which a signal propagates without requiring clock transitions. Such paths may traverse only Boolean primitives. A cyclical path (or a loop) of a circuit design is a timing path originating from the output of a primitive and reaching the input of the same primitive forming a feedback path.

A strongly connected component of a circuit design includes one or more primitives. In a strongly connected component a timing path exits from any primitive of the strong connected component to the input of every primitive, including the primitive from which the timing path exited, forming a cyclical path. A strongly connected component can include one or more cyclical paths. A strongly connected component includes one or more inputs. An input is a connection that terminates at a primitive that is part of a strongly connected component and originates at a primitive that is not part of the same strongly connected component. Further, a strongly connected component includes one or more outputs. An output is a connection that originates at a primitive that is part of a strongly connected component and terminates at a primitive that is not part of the same strongly connected component.

### SUMMARY

In one example, a method includes obtaining a circuit design, and determining, by a processor, a first strongly connected component within the circuit design and generating replica strongly connected components and an output support sub-circuit from the first strongly connected component. The method further includes updating the circuit design based on the replica strongly connected components and the output support sub-circuit. Further, the method includes verifying the updated circuit design by emulating the updated circuit design.

In one example, a system includes a memory storing instructions, and one or more processors. The one or more processors are coupled with the memory execute the instructions. The instructions, when executed, cause the one or more processors to obtain a circuit design, and determine a first strongly connected component within the circuit design and generating replica strongly connected components and an output support sub-circuit from the first strongly connected component. The processor is further caused to update the circuit design based on the replica strongly connected components and the output support sub-circuit. Further, the processor is caused to verify the updated circuit design by emulating the updated circuit design.

In one example, a non-transitory computer readable medium including stored instructions, which when executed by one or more processors, cause the one or more processors to generating a replica strongly connected components and an output support sub-circuit for a first strongly connected component within a circuit design. The processors are further caused to update the circuit design based on the replica strongly connected components and the output support sub-circuit. Further, the processors are caused to verify the updated circuit design by emulating the updated circuit design.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 depicts a flowchart for generating an updated circuit design in accordance with some embodiments of the present disclosure.

FIG. 2 depicts a flowchart for generating replica strongly connected components and output support sub-circuits in accordance with some embodiments of the present disclosure.

FIG. 3 illustrates a strongly connected component in accordance with some embodiments of the present disclosure.

FIG. 4 illustrates a strongly connected component with a feedback vertex set in accordance with some embodiments of the present disclosure.

FIG. 5 illustrates replica strongly connected components and an output support sub-circuit in accordance with some embodiments of the present disclosure.

FIG. 6 illustrates a strongly connected component in accordance with some embodiments of the present disclosure.

FIG. 7 illustrates replica strongly connected components and an output support sub-circuit in accordance with some embodiments of the present disclosure.

FIG. 8 illustrates a strongly connected component in accordance with some embodiments of the present disclosure.

FIG. 9 illustrates replica strongly connected components and an output support sub-circuit in accordance with some embodiments of the present disclosure.

FIG. 10 depicts a flowchart of various processes used during the design and manufacture of an integrated circuit in accordance with some embodiments of the present disclosure.

FIG. 11 depicts a diagram of an example emulation system in accordance with some embodiments of the present disclosure.

FIG. 12 depicts a diagram of an example computer system in which embodiments of the present disclosure may operate.

### DETAILED DESCRIPTION

Aspects of the present disclosure relate to mitigating effects of cyclic timing paths within a circuit design. During the circuit design process, the circuit designs are emulated to detect errors within the circuit design and to confirm the correct operation of the circuit design. A circuit designs include digital circuits and/or analog circuits. A circuit design may be represented as a netlist. For example, the schematic representation of the circuit design is converted into a netlist during the design and verification process.

A netlist is a description of the connectivity of components within the circuit design. A netlist includes the electronic components of the circuit design and the nodes to which the electronic components are connected. The nodes of the graph structure represent how the electronic components are interconnected. During circuit design verification, the netlist is checked for compliance with operating parameters including timing constraints of how signals flow through and between the electronic components of the circuit design.

A circuit design may be represented as a directed graph structure. In a directed graph structure, primitives (e.g., Boolean function primitives and/or registers, among others) of a circuit design correspond to the nodes and wire segments correspond to the edges between the nodes. The primitives correspond to the electrical components of the circuit design. In one or more examples, primitives are the basic building blocks for of the circuit design.

In a synchronous circuit design, one or more wires are designated as clocks (e.g., routing for clock signals). Further, in a synchronous circuit design, a state within the circuit design changes contemporaneously with transitions of the clocks (e.g., voltage transitions or edges of clock signals). In a circuit design, input signals are input to primitives, which are connected to outputs of circuit design. In one example, one or more of the primitives propagate changes to the input signal to the corresponding outputs without requiring transitions of a clock or clocks. Further, one or more of the primitives propagate changes to an input signal based on transitions of a clock or clocks.

Circuit designs include paths that define how signals propagate through the electrical components of the circuit design. In one example, the paths are timing paths. A timing path defines the sequence of connections through which a signal propagates without requiring transitions of a clock. In one example, timing paths traverse primitives. In other examples, timing paths traverse only Boolean primitives. A circuit design may include cyclical paths (or loops). A cyclical path is a timing path originating from the output of a primitive and reaching the input of the same primitive forming a feedback path.

Circuit designs include strongly connected components (SCCs). An SCC of a circuit design includes one or more primitives. In an SCC, a timing path exits from any primitive of the SCC to the input of every primitive, including the primitive from which the timing path exited, forming a cyclical path. A cyclical path may start and end at the same primitive. An SCC can include one or more cyclical paths. In one or more examples, an SCC includes one or more inputs. An input is a connection that terminates at a primitive that is part of an SCC and originates at a primitive that is not part of the same SCC. Further, an SCC includes one or more outputs. An output is a connection that originates at a primitive that is part of an SCC and terminates at a primitive that is not part of the same SCC.

In a circuit design, SCCs compromise the synchronous nature of the circuit design. For example, due to the SCCs, an output value of a signal or signals may be hard to determine during verification.

An emulation process is used to determine the operational parameters (e.g., timing parameters, among others) of a circuit design. In an emulation process, a circuit design is implemented in one or more field-programmable gate arrays (FPGAs), and/or other types of processing devices, by mapping the functions and operations of the circuit design to one or more of the FPGAs. In an emulation process, SCCs negatively affect the emulation process. For example when performing the emulation process, an SCC may be remapped to the FPGAS multiple times. Each time a remapping process is performed for an SCC, the detailed behavior of the SCC may change due to different physical delays of the connections of the electrical components of the SCC. Due to the remapping and changes, performing the emulation process to verify a circuit design is computationally complex and time consuming.

In one or more examples, SCCs are removed from a circuit design before the emulation process is performed. For example, registers may be inserted into one or more paths of the SCC such that the registers interrupt the cyclical timing paths. However, if a register is inserted in such a way that the register also interrupts a non-cyclical timing path from any SCC input to any of the outputs of the SCC, the functioning of the circuit design may be incorrect (e.g., different from that intended during the design process).

In one or more examples, an SCC is broken (split or divided) into multiple SCCs. An SCC may be broken up when the inserted registers interrupt all of the cyclical timing paths but do not interrupt any of the non-cyclical timing paths from inputs to outputs of the SCC. In an SCC with a single output, breaking can be accomplished by inserting a register along the path that leads from the output of the SCC back to the input or inputs of the primitives within the SCC (e.g., the feedback connection). However, in an example where an SCC has multiple outputs, a feedback connection may be part of a cyclical and non-cyclical path. Accordingly, breaking all of the feedback connections of a multi-output SCC may be unsafe in that breaking a multi-output SCC may change the functionality of the corresponding circuit design.

The circuit design verification process as described herein generates one or more copies (e.g., replicas) of an SCC when cyclical timing paths are detected. Further, the electrical components that are between the termination of the cyclical timing paths and the output of the SCCs are added to an output support sub-circuit and connected to the output of the replica SCCs such that the functionality of the corresponding circuit design is not changed. This process is completed recursively until no SCCs are detected. The circuit design is updated with the replica SCCs and the output support sub-circuits, and the updated circuit design is used during the emulation process to verify the operation of the circuit design.

The technical advantages of the present disclosure include, but are not limited to, generating replica SCCs and corresponding output support sub-circuits to mitigate cyclical paths within the corresponding circuit design. Accordingly, the complexity of the emulation and verification process is reduced, reducing the processing time and processing resources used to emulate and verify the circuit design. Further, the process described herein mitigates errors that may occur during the emulation and verification process as compared to previous methods for mitigating the effects of cyclical paths. Accordingly, semiconductor devices designed using the processes described herein have a lower design cost than that of semiconductors devices designed using other processes.

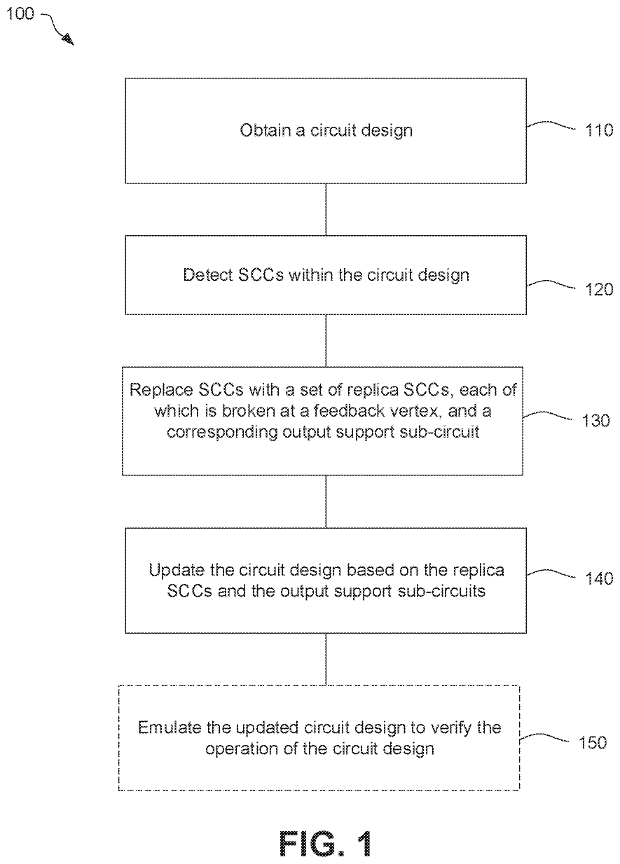

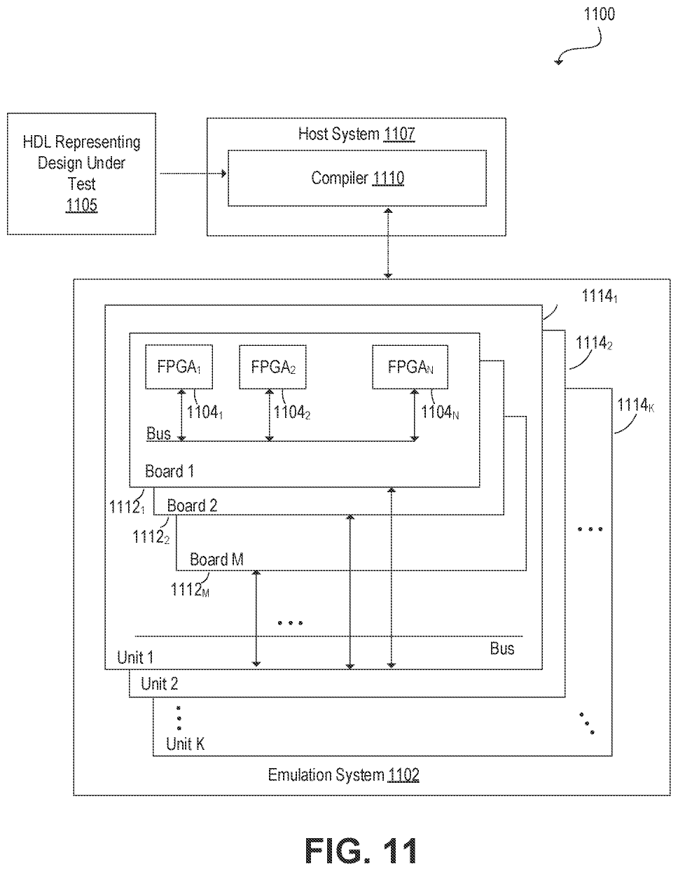

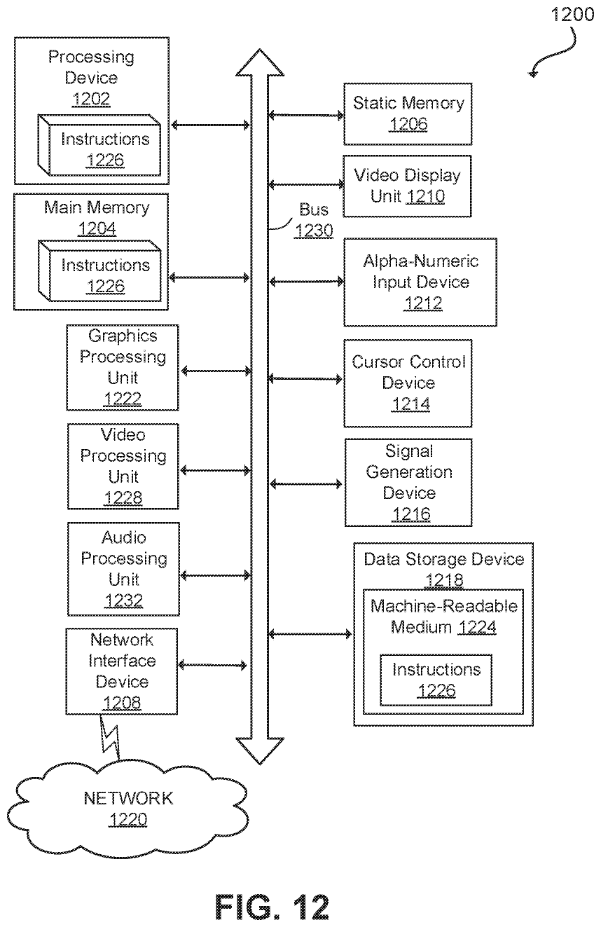

FIG. 1 illustrates a flowchart of a method 100 for generating an updated circuit design to circuit design emulation by detecting and mitigate SCCs within the circuit design. In one example, the method 100 is performed by a computer system (such as computer system 1200 of FIG. 12 or host system 1107 of FIG. 11). In one example, a processing device (e.g., the processing device 1202 of FIG. 12) executes instructions (e.g., the instructions 1226 of FIG. 12) stored within a memory (e.g., the main memory 1204 of FIG. 12 and/or the machine-readable medium 1224 of FIG. 12) to perform the method 100.

At 110, a circuit design is obtained. In one example, the processing device 1202 obtains a circuit design from a memory (e.g., the main memory 1204 of FIG. 12 and/or the machine-readable medium 1224 of FIG. 12). The circuit design may be represented as a netlist.

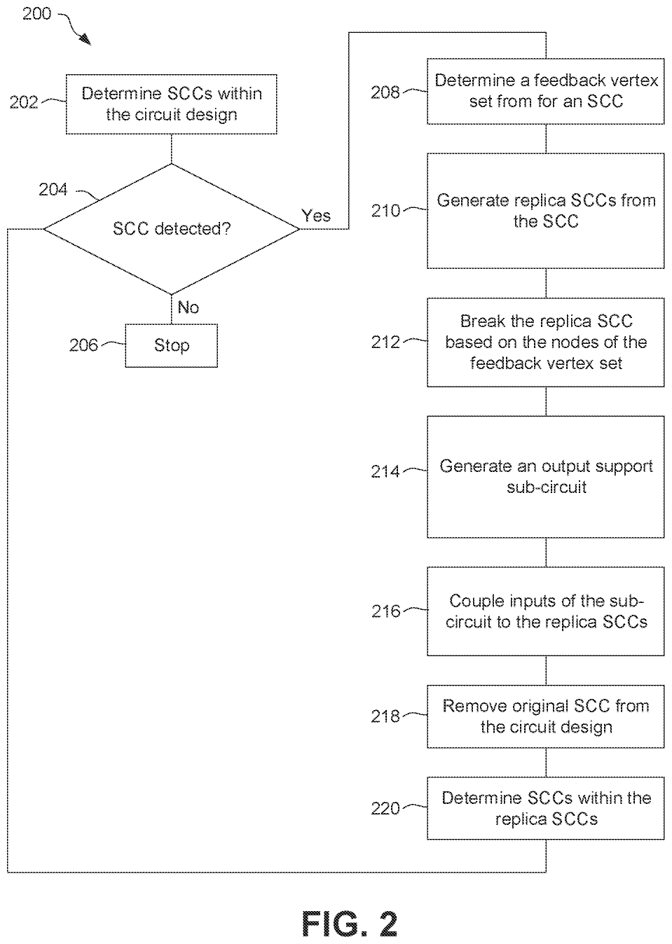

At 120, SCCs within the circuit design are detected. For example, the processing device 1202 detects SCCs within the circuit design. 120 of the method 100 is described in greater detail with regard to 202 of the method 200 of FIG. 2.

At 130, SCCs are replaced with a set of replica SCCs, each of which is broken at a feedback vertex, and a corresponding output support sub-circuit. For example, the processing device 1202 replaces an SCC with a set of replica SCCs, each of which is broken at a feedback vertex, and a corresponding output support sub-circuit. As is described in further detail with regard to method 200, the replica SCCs are generated from the detected SCCs. Further, output support sub-circuits generated for the detected SCCs and are connected the corresponding replica SCCs. In one or more examples, each replica SCC outputs a different signal to the output support sub-circuit.

FIG. 2 illustrates method 200 including further details with regard to detecting SCCs in a circuit design and replacing the SCCs with a set of replica SCCs, each of which is broken at a feedback vertex, and a corresponding output support sub-circuit. In one example, the method 200 may replace 120 and 130 in the method 100 of FIG. 1. For example, at the complete of 206 of the method 200, 140 of the method 100 of FIG. 1 is performed.

At 202, SCCs within the circuit design are determined. For example, the processing device 1202 detects SCCs within the circuit design. In one example, SCCs are detected by detecting cyclic paths within the circuit design. In one or more examples, the netlist of the circuit design is searched to detect cyclic portions of the circuit design. In one example, a depth first search is used to detect the cyclic portions. In a depth first search, when a node is reached that has been already been visited a cyclic portion is detected. The cyclic portions include one or more cyclic paths. A cyclic portion is an SCC. The detected SCCs are stored in a memory (e.g., the main memory 1204 of FIG. 12 or the machine-readable medium 1224 of FIG. 12).

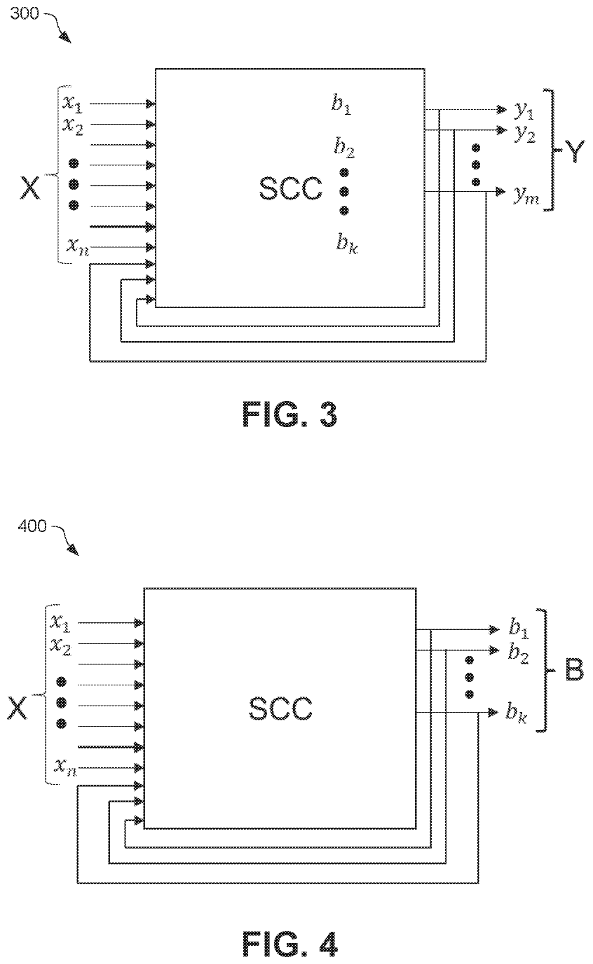

FIG. 3 illustrates an example SCC, SCC 300. The SCC includes inputs X (x₁-xₙ) and includes outputs Y (y₁-yₘ). As is illustrated in FIG. 3, the one or more of the outputs y₁-yₘ is connected back to electronic components within the SCC, forming cyclic paths within the SCC 300.

At 204, a determination as to whether or not an SCC is detected is made. For example, the processing device 1202 determines whether or not an SCC is detected based on the output of 202. In one example, the processing device 1202 determines whether or not an SCC or SCCs are stored within the memory. At 206, if no SCCs are detected at 204, the process ends.

If at 204 an SCC is detected, a feedback vertex set (FVS) for an SCC is determined at 208. In one example, the processing device 1202 determines an FVS for an SCC. An FVS includes a set of vertices (nodes) of a graph, where the removal of vertices from the graph makes the graph acyclic. In an SCC, removal of the nodes of an FVS by inserter a register at locations associated with the nodes makes the SCC and corresponding paths within the SCC acyclic. The processing device 1202 obtains an SCC from the memory (e.g., the main memory 1204 of FIG. 12 and/or the machine-readable medium 1224 of FIG. 12). The FVS is determined by applying a set of operations to transform the netlist (or other graphical representation) of the circuit design by applying a series of contraction operations. The series of contractions do not alter the size of the minimum FVS (MFVS). For example, the contraction operations preserve the size of the minimum feedback set but reduce the total vertices in the graph. The reduced graph is processed (e.g., analyzed) to determine nodes associated cyclic paths. Nodes determined to be associated with cyclic paths are added to the FVS. With reference to FIG. 3, b₁-bₖ are nodes (e.g., edges) associated with cyclic paths within the SCC 300. The nodes b₁-bₖ form the FVS for the SCC 300.

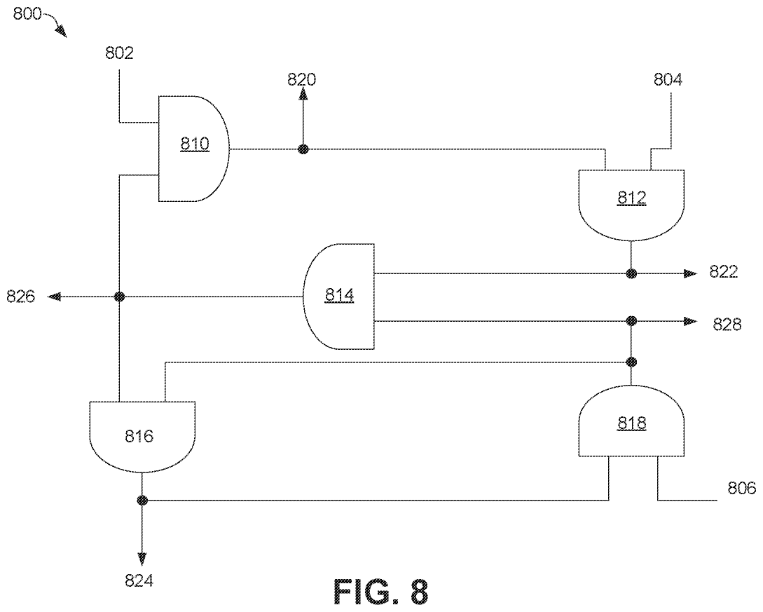

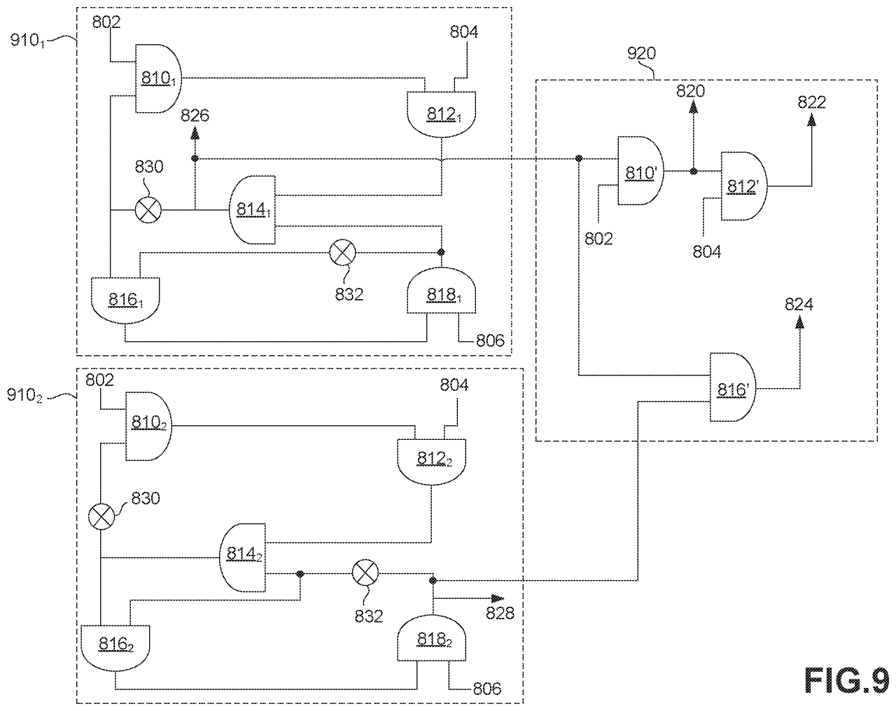

At 210, replica SCCs are generated from the SCC by creating copies of each component that is included in the SCC and connecting each component to copies of components to which the original component was connected in the original SCC. For example, as is illustrated in FIGS. 8 and 9, the replica SCCs 910 are generated from the SCC 800. Each replica SCC 910 includes a copy of each of the primitives 810, 812, 814, 816 and 818, which are the components forming the SCC 800. Further, the connections between the primitives in each replica SCC 910 correspond to the connections of the SCC 800.

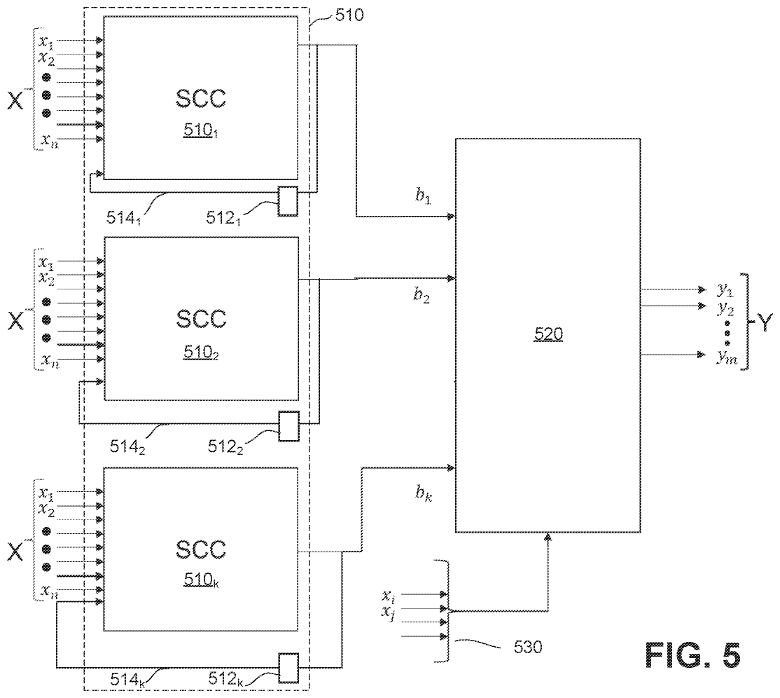

The number of replica SCCs correspond to the number of nodes in the corresponding FVS. In one example, the processing device 1202 generates a replica SCC for each node in the FVS. FIG. 4 illustrates the SCC 400. The SCC 400 is the SCC 300 with the nodes b₁-bₖ (e.g., nodes of the FVS) set as the outputs of the SCC 300. In one example, generating replica SCCs for each node in the FVS includes setting the nodes of the FVS as the outputs, and generating an updated SCC (e.g., the SCC 400). A replica SCC is generated for each node b₁-bₖ of the FVS. For example, as illustrated in FIG. 5, replica SCCs 510 are generated for the nodes b from the SCC 400 of FIG. 4. The replica SCC 510₁ is generated for the node b₁, the replica SCC 5102 is generated for the node b₂, and the replica SCC 510k is generated for the node bₖ. In each replica SCC 510, the corresponding node b is set as the output. The replica SCCs 510 are stored in a memory (e.g., the main memory 1204 of FIG. 12 and/or the machine-readable medium 1224 of FIG. 12).

At 212, the replica SCC are broken based on the nodes of the FVS. For example, the processing device 1202 breaks the feedback path (loop) associated with each replica SCC and corresponding FVS node. In one example, breaking a feedback includes inserting a register within each feedback path between the FVS node and the input to the replica SCC. With reference to FIG. 5, the processing device 1202 determines each feedback path 514. Further, the processing device 1202 inserts a register 512 within each feedback path 514. The registers “break” the feedback paths 514, removing the cyclical timing for the associated node and primitive. In one or more examples, the register 512₁ is included in the feedback path 514₁, the register 512₂ is included in the feedback path 514₂, and the register 512ₖ is included in the feedback path 514k. The feedback path 514₁ is between the node by and the input to the replica SCC 510₁, the feedback path 514₂ is between the node b₂ and the input to the replica SCC 510₂, and the feedback path 514ₖ is between the node bₖ and the input to the replica SCC 510ₖ. The replica SCCs 510 and the registers 512, and association between replica SCCs and the registers 512 are stored in a memory (e.g., the main memory 1204 of FIG. 12 and/or the machine-readable medium 1224 of FIG. 12).

At 214, an output support sub-circuit is generated. In one example, the processing device 1202 generates the output support sub-circuit. The output support sub-circuit is generated from the original SCC. In one example, backward traversal is performed from the outputs of the original SCC (e.g., the SCC 300) to determine the output support sub-circuit. With reference to the SCC 300 of FIG. 3, and the replica SCCs 510 of FIG. 5, the output support sub-circuit 520 is generated by performing a backwards traversal starting from the outputs y₁-yₘ. Performing the backwards traversal includes starting from one of the outputs y₁-yₘ, and identify and collecting the primitives coupled to the output and the corresponding connections until the backwards traversal reaches primitives that is part of the FVS, an primitive that has already been identified and collected, or one of the inputs x₁-xₙ is reached. The identified primitives are collected and generate the output support sub-circuit 520. Accordingly, the paths of output support sub-circuit 520 are acyclic. In one example, the inputs x₁-xₙ that are reached during the backwards traversal process are included as inputs 530 that are coupled directly to the output support sub-circuit 520. The inputs 530 includes one or more of the inputs x₁-xₙ. The output support sub-circuit 520 is stored in a memory (e.g., the main memory 1204 of FIG. 12 and/or the machine-readable medium 1224 of FIG. 12).

At 216, inputs of the output support sub-circuit are coupled to the replica SCCs. For example, the processing device 1202 couples the inputs of the output support sub-circuit to the replica SCC. With reference to FIG. 5, the inputs of the output support sub-circuit 520 are coupled to the replica SCCs 510. In one example, the replica SCCs 510 are coupled to the output support sub-circuit 520 via the nodes b. For example, the replica SCC 510₁ is coupled to the output support sub-circuit 520 via the node b₁, the replica SCC 510₂ is coupled to the output support sub-circuit 520 via the node b₂, and the replica SCC 510ₖ is coupled to the output support sub-circuit 520 via the node br. As the output support sub-circuit 520 is generated by backwards traversal from the outputs of the original SCC (e.g., the SCC 300 of FIG. 5), the outputs of the output support sub-circuit 520 corresponds to the outputs of the original SCC. The coupled replica SCCs 510 and the output support sub-circuit 520 are stored in in a memory (e.g., the main memory 1204 of FIG. 12 and/or the machine-readable medium 1224 of FIG. 12).

At 218, the original SCC is removed from the circuit design. For example, the processing device 1202 removes the original SCC from the circuit design. In one example, removing the original SCC includes replacing the original SCC with the replica SCCs and output support sub-circuit determined during 208-216 of FIG. 2. With reference to FIG. 3 and FIG. 5, the SCC 300 is removed from the corresponding circuit design. In one example, the replica SCCs 510 and the output support sub-circuit 520 are disposed within the circuit design in place of the SCC 300.

In one example, the replica SCCs and corresponding output support sub-circuit have the same functionality as the original SCC. For example, the replica SCCs 510 and the output support sub-circuit 520 of FIG. 5 have the same functionality (e.g., operation) as the SCC 300.

At 220, SCCs within the replica SCCs are determined. The processing device 1202 determines whether or not SCCs are present within the replica SCCs. An SCC is determined to be within the replica SCC if cyclic paths are detected within the replica SCC as described with regard to 202. The detected SCCs are stored in a memory (e.g., the main memory 1204 of FIG. 12 and/or the machine-readable medium 1224 of FIG. 12). The method 200 returns to 204, where a decision as to whether or not any SCCs are detected is made. If SCCs are detected at 220, the 202-220 are repeated for each of the SCCs. If no SCCs are detected at 220, the method 200 ends. In one example, to determine whether or not SCCs are detected, the processing device 1202 determines whether or not SCCs are stored in the memory.

In one or more examples, 208-220 is performed on each SCC determined (e.g., detected) at 202. In one example, 208-220 is performed on two or more detected SCCs during at least partially overlapping periods. In one or more examples, 208-220 are performed on two or more of the detected SCCs during non-overlapping periods.

With further reference to the method 100 of FIG. 1, at 140 the circuit design is updated based on the replica SCCs and the output support sub-circuits. For example, the processing device 1202 generates the updated circuit design by replacing SCCs removed at 218 of FIG. 2 with the replica SCCs and corresponding output support sub-circuits. The updated circuit design is stored in a memory (e.g., the main memory 1204 of FIG. 12 and/or the machine-readable medium 1224 of FIG. 12). The operation of the updated circuit design is unchanged as compared to the original circuit design.

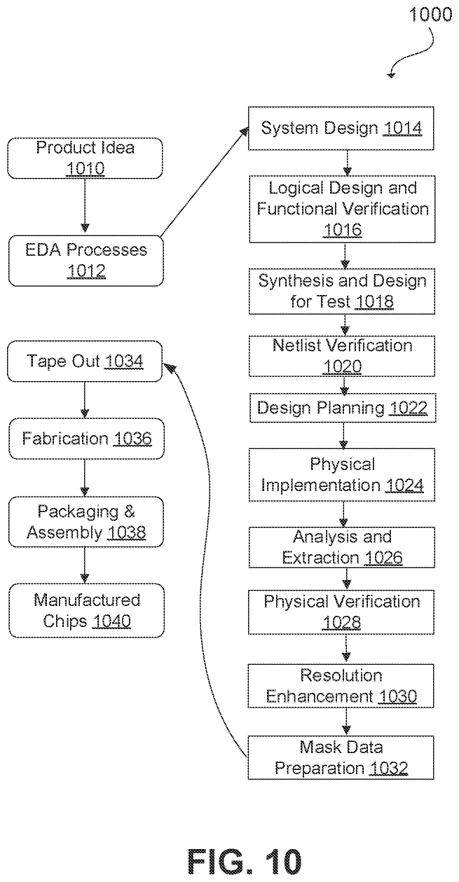

In one example, the method 100 includes 150, emulating the updated circuit design to verify the operation of the circuit design. For example, the updated circuit design is obtained from the memory and used by the host system 1107 during an emulation process to verify the operation of the circuit design as is described with regard to the emulation process of FIG. 11. In one example, 150 is omitted from the method 100. Further, in one or more examples, 150 is performed by the host system 1107 of FIG. 11 and the computer system 1200 performs 110-140. In one example, a integrated circuit device, or semiconductor device, is manufactured as described in processes 1000 of FIG. 10 from the verified (e.g., emulated) circuit design.

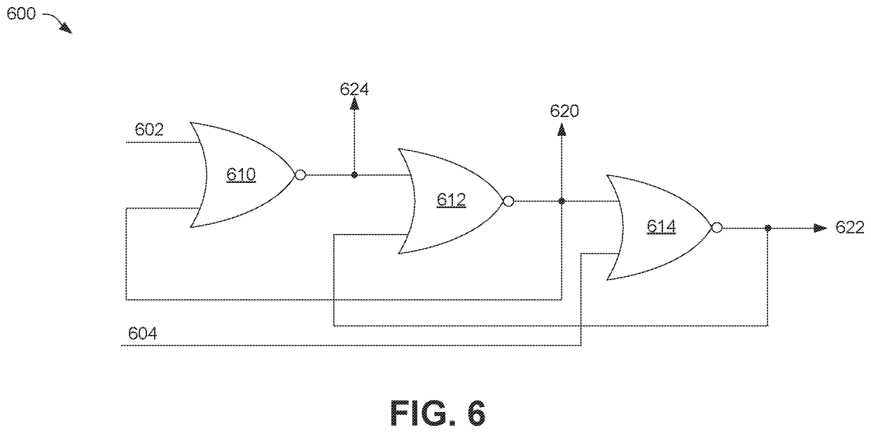

FIG. 6 illustrates the SCC 600. The SCC includes inputs 602 and 604, primitives (e.g., logic gates) 610-614, and outputs 620-624. In one example, 208-216 of FIG. 2 are performed on the SCC 600 to identify an FVS including one edge indicated at the output of primitive 612. As there is only one node (or edge in the FVS), there is a single SCC 700 formed from the SCC 600. The SCC 700 is a replica SCC. The SCC 700 includes a break 630 placed at the output of the primitive 612. The break 630 is a representative of a register (or break register or register stage). For example, a register is inserted within the SCC 700 at the break 630. Inserting the register at the break 630 makes the SCC 700 loop free and the SCC 700 is acyclic.

The output support sub-circuit 710 is generated by performing a backwards traversal from outputs 620-624 as is described by 214 of FIG. 2. Performing backwards traversal from output 622 determines that the primitive (e.g., logic gate) 614 is used to generate the output 622 based on the input 604 and the output of the primitive 612. Backwards traversal from the output 622 stops at the inputs to the primitive 614 as the break 630 is at the output of the primitive 612 and the input to the primitive 614. The primitive 614′ is added to the output support sub-circuit 710, having inputs connected to the input 604 and the output of the primitive 612.

Performing backwards traversal from output 624 determines that the primitive (e.g., logic gate) 610 is used to generate the output 624 based on the input 602 and the output of the primitive 612. Backwards traversal from the output 624 stops at the inputs to the primitive 610 as the input 602 is the input to the SCC 600. The primitive 610′ is added to the output support sub-circuit 710, having inputs connected to the input 602 and the output of the primitive 612. The output support sub-circuit 710 is coupled to the SCC 700.

FIG. 8 illustrates the SCC 800. The SCC includes inputs 802, 804, and 806, primitives (e.g., logic gates) 810-818, and outputs 820-828. In one example, 208-216 of FIG. 2 are performed on the SCC 800 to identify an FVS including edges indicated by breaks 830 and 832 at the outputs of primitives 814 and 818 of FIG. 9. As there are two edges within the FVS, two replica SCCs 9101 and 9102 are formed from the SCC 800. The replica SCC 9101 generates the FVS edge (node) at output 826. As the output of the primitive 8141 corresponds to an edge of the FVS, a register is disposed at the break 830. Accordingly, the register at break 830 is disposed along the feedback path from the output of the primitive 8141 to the inputs of the primitives 8101 and 8161. By examining the resulting circuit, a determination that the resulting circuit is not loop-free is made. For example, a second SCC comprising the primitives 8181 and 8161 is detected. The FVS of the second SCC is determined as the primitive 8181, accordingly, a new register at break 832 is inserted at the corresponding feedback leading from an output of the primitive 8181 to input of the primitive 8161. As the output of the primitive 8181 to the primitive 8141 is also an SCC output, an output support sub-circuit is not created. The replica SCC 9101 is determined to be loop-free and acyclical.

The replica SCC 9102 generates the FVS edge (node) at output 828. The output of the primitive 8182 corresponds to the FVS edge at output 828. A register is disposed at the break 832. Accordingly, the register is disposed along the feedback path from the output of the primitive 8182 to the inputs of the primitives 8142 and the input of the primitive 8162. The resulting circuit is determined to not be loop-free.

A second SCC is determined to exist, being comprised of the primitives 8142, 8122 and 8102. The FVS of this second SCC is determined to be the primitive 8142. Accordingly, a register at break 832 is inserted at its feedback leading from output of primitive 8142 to input of primitive 8102. The output of the primitive 8142 to the primitive 8162 is an SCC output, and a corresponding output support sub-circuit not generated. The replica SCC 9102 is determined to be loop-free and acyclical.

The output support sub-circuit 920 is generated by performing a backwards traversal from the outputs 820-826 as is described by 214 of FIG. 2. Performing backwards traversal from the outputs 820-826 determines that the primitives (e.g., logic gates) 810, 812, and 816 are part of the output support sub-circuit 920 (e.g., labeled as 810′, 812′, and 816′). The primitives 810′, 812′, and 814′ are added to the output support sub-circuit 920 and coupled to the outputs for the replica SCCs 910. Further, as the outputs 826 and 828 directly correspond to FVS nodes, the outputs 826 and 828 are not reconstructed and corresponding sub-circuits are not created.

FIG. 10 illustrates an example set of processes 1000 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 1010 with information supplied by a designer, information which is transformed to create an article of manufacture that uses a set of EDA processes 1012. When the design is finalized, the design is taped-out 1034, which is when artwork (e.g., geometric patterns) for the integrated circuit is sent to a fabrication facility to manufacture the mask set, which is then used to manufacture the integrated circuit. After tape-out, a semiconductor die is fabricated 1036 and packaging and assembly processes 1038 are performed to produce the finished integrated circuit 1040.

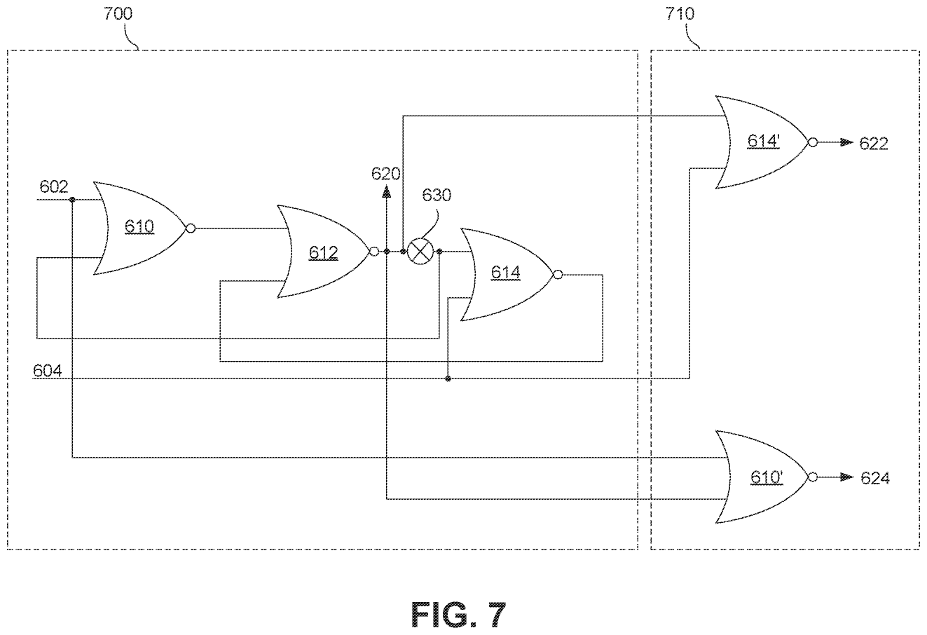

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or Open Vera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 7. The processes described by be enabled by EDA products (or EDA systems).

During system design 1014, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 1016, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 1018, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 1020, the netlist is checked for compliance with timing constraints and for correspondence with the HDL code. During design planning 1022, an overall floor plan for the integrated circuit is constructed and analyzed for timing and top-level routing.

During layout or physical implementation 1024, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 1026, the circuit function is verified at the layout level, which permits refinement of the layout design. During physical verification 1028, the layout design is checked to ensure that manufacturing constraints are correct, such as DRC constraints, electrical constraints, lithographic constraints, and that circuitry function matches the HDL design specification. During resolution enhancement 1030, the geometry of the layout is transformed to improve how the circuit design is manufactured.

During tape-out, data is created to be used (after lithographic enhancements are applied if appropriate) for production of lithography masks. During mask data preparation 1032, the ‘tape-out’ data is used to produce lithography masks that are used to produce finished integrated circuits.

A storage subsystem of a computer system (such as computer system 1200 of FIG. 12, or host system 1107 of FIG. 8) may be used to store the programs and data structures that are used by some or all of the EDA products described herein, and products used for development of cells for the library and for physical and logical design that use the library.

FIG. 11 depicts a diagram of an example emulation environment 1100. An emulation environment 1100 may be configured to verify the functionality of the circuit design. The emulation environment 1100 may include a host system 1107 (e.g., a computer that is part of an EDA system) and an emulation system 1102 (e.g., a set of programmable devices such as Field Programmable Gate Arrays (FPGAs) or processors). The host system generates data and information by using a compiler 1110 to structure the emulation system to emulate a circuit design. A circuit design to be emulated is also referred to as a Design Under Test (‘DUT’) where data and information from the emulation are used to verify the functionality of the DUT.

The host system 1107 may include one or more processors. In the embodiment where the host system includes multiple processors, the functions described herein as being performed by the host system can be distributed among the multiple processors. The host system 1107 may include a compiler 1110 to transform specifications written in a description language that represents a DUT and to produce data (e.g., binary data) and information that is used to structure the emulation system 1102 to emulate the DUT. The compiler 1110 can transform, change, restructure, add new functions to, and/or control the timing of the DUT.

The host system 1107 and emulation system 1102 exchange data and information using signals carried by an emulation connection. The connection can be, but is not limited to, one or more electrical cables such as cables with pin structures compatible with the Recommended Standard 232 (RS232) or universal serial bus (USB) protocols. The connection can be a wired communication medium or network such as a local area network or a wide area network such as the Internet. The connection can be a wireless communication medium or a network with one or more points of access using a wireless protocol such as BLUETOOTH or IEEE 1102.11. The host system 1107 and emulation system 1102 can exchange data and information through a third device such as a network server.

The emulation system 1102 includes multiple FPGAs (or other modules) such as FPGAs 11041 and 11042 as well as additional FPGAs to 1104N. Each FPGA can include one or more FPGA interfaces through which the FPGA is connected to other FPGAs (and potentially other emulation components) for the FPGAs to exchange signals. An FPGA interface can be referred to as an input/output pin or an FPGA pad. While an emulator may include FPGAs, embodiments of emulators can include other types of logic blocks instead of, or along with, the FPGAs for emulating DUTs. For example, the emulation system 1102 can include custom FPGAs, specialized ASICs for emulation or prototyping, memories, and input/output devices.

A programmable device can include an array of programmable logic blocks and a hierarchy of interconnections that can enable the programmable logic blocks to be interconnected according to the descriptions in the HDL code. Each of the programmable logic blocks can enable complex combinational functions or enable logic gates such as AND, and XOR logic blocks. In some embodiments, the logic blocks also can include memory elements/devices, which can be simple latches, flip-flops, or other blocks of memory. Depending on the length of the interconnections between different logic blocks, signals can arrive at input terminals of the logic blocks at different times and thus may be temporarily stored in the memory elements/devices.

FPGAs 1104₁-1104_{N} may be placed onto one or more boards 1112₁ and 1112₂ as well as additional boards through 1112_{M}. Multiple boards can be placed into an emulation unit 1114₁. The boards within an emulation unit can be connected using the backplane of the emulation unit or any other types of connections. In addition, multiple emulation units (e.g., 1114₁ and 1114₂ through 1114_{K}) can be connected to each other by cables or any other means to form a multi-emulation unit system.

For a DUT that is to be emulated, the host system 1107 transmits one or more bit files to the emulation system 1102. The bit files may specify a description of the DUT and may further specify partitions of the DUT created by the host system 1107 with trace and injection logic, mappings of the partitions to the FPGAs of the emulator, and design constraints. Using the bit files, the emulator structures the FPGAs to perform the functions of the DUT. In some embodiments, one or more FPGAs of the emulators may have the trace and injection logic built into the silicon of the FPGA. In such an embodiment, the FPGAs may not be structured by the host system to emulate trace and injection logic.

The host system 1107 receives a description of a DUT that is to be emulated. In some embodiments, the DUT description is in a description language (e.g., a register transfer language (RTL)). In some embodiments, the DUT description is in netlist level files or a mix of netlist level files and HDL files. If part of the DUT description or the entire DUT description is in an HDL, then the host system can synthesize the DUT description to create a gate level netlist using the DUT description. A host system can use the netlist of the DUT to partition the DUT into multiple partitions where one or more of the partitions include trace and injection logic. The trace and injection logic traces interface signals that are exchanged via the interfaces of an FPGA. Additionally, the trace and injection logic can inject traced interface signals into the logic of the FPGA. The host system maps each partition to an FPGA of the emulator. In some embodiments, the trace and injection logic is included in select partitions for a group of FPGAs. The trace and injection logic can be built into one or more of the FPGAs of an emulator. The host system can synthesize multiplexers to be mapped into the FPGAs. The multiplexers can be used by the trace and injection logic to inject interface signals into the DUT logic.

The host system creates bit files describing each partition of the DUT and the mapping of the partitions to the FPGAs. For partitions in which trace and injection logic are included, the bit files also describe the logic that is included. The bit files can include place and route information and design constraints. The host system stores the bit files and information describing which FPGAs are to emulate each component of the DUT (e.g., to which FPGAs each component is mapped).

Upon request, the host system transmits the bit files to the emulator. The host system signals the emulator to start the emulation of the DUT. During emulation of the DUT or at the end of the emulation, the host system receives emulation results from the emulator through the emulation connection. Emulation results are data and information generated by the emulator during the emulation of the DUT which include interface signals and states of interface signals that have been traced by the trace and injection logic of each FPGA. The host system can store the emulation results and/or transmits the emulation results to another processing system.

After emulation of the DUT, a circuit designer can request to debug a component of the DUT. If such a request is made, the circuit designer can specify a time period of the emulation to debug. The host system identifies which FPGAs are emulating the component using the stored information. The host system retrieves stored interface signals associated with the time period and traced by the trace and injection logic of each identified FPGA. The host system signals the emulator to re-emulate the identified FPGAs. The host system transmits the retrieved interface signals to the emulator to re-emulate the component for the specified time period. The trace and injection logic of each identified FPGA injects its respective interface signals received from the host system into the logic of the DUT mapped to the FPGA. In case of multiple re-emulations of an FPGA, merging the results produces a full debug view.

The host system receives, from the emulation system, signals traced by logic of the identified FPGAs during the re-emulation of the component. The host system stores the signals received from the emulator. The signals traced during the re-emulation can have a higher sampling rate than the sampling rate during the initial emulation. For example, in the initial emulation a traced signal can include a saved state of the component every X milliseconds. However, in the re-emulation the traced signal can include a saved state every Y milliseconds where Y is less than X. If the circuit designer requests to view a waveform of a signal traced during the re-emulation, the host system can retrieve the stored signal and display a plot of the signal. For example, the host system can generate a waveform of the signal. Afterwards, the circuit designer can request to re-emulate the same component for a different time period or to re-emulate another component.

A host system 1107 and/or the compiler 1110 may include sub-systems such as, but not limited to, a design synthesizer sub-system, a mapping sub-system, a run time sub-system, a results sub-system, a debug sub-system, a waveform sub-system, and a storage sub-system. The sub-systems can be structured and enabled as individual or multiple modules or two or more may be structured as a module. Together these sub-systems structure the emulator and monitor the emulation results.

The design synthesizer sub-system transforms the HDL that is representing a DUT 1105 into gate level logic. For a DUT that is to be emulated, the design synthesizer sub-system receives a description of the DUT. If the description of the DUT is fully or partially in HDL (e.g., RTL or other level of representation), the design synthesizer sub-system synthesizes the HDL of the DUT to create a gate-level netlist with a description of the DUT in terms of gate level logic.

The mapping sub-system partitions DUTs and maps the partitions into emulator FPGAs. The mapping sub-system partitions a DUT at the gate level into a number of partitions using the netlist of the DUT. For each partition, the mapping sub-system retrieves a gate level description of the trace and injection logic and adds the logic to the partition. As described above, the trace and injection logic included in a partition is used to trace signals exchanged via the interfaces of an FPGA to which the partition is mapped (trace interface signals). The trace and injection logic can be added to the DUT prior to the partitioning. For example, the trace and injection logic can be added by the design synthesizer sub-system prior to or after the synthesizing the HDL of the DUT.

In addition to including the trace and injection logic, the mapping sub-system can include additional tracing logic in a partition to trace the states of certain DUT components that are not traced by the trace and injection. The mapping sub-system can include the additional tracing logic in the DUT prior to the partitioning or in partitions after the partitioning. The design synthesizer sub-system can include the additional tracing logic in an HDL description of the DUT prior to synthesizing the HDL description.

The mapping sub-system maps each partition of the DUT to an FPGA of the emulator. For partitioning and mapping, the mapping sub-system uses design rules, design constraints (e.g., timing or logic constraints), and information about the emulator. For components of the DUT, the mapping sub-system stores information in the storage sub-system describing which FPGAs are to emulate each component.

Using the partitioning and the mapping, the mapping sub-system generates one or more bit files that describe the created partitions and the mapping of logic to each FPGA of the emulator. The bit files can include additional information such as constraints of the DUT and routing information of connections between FPGAs and connections within each FPGA. The mapping sub-system can generate a bit file for each partition of the DUT and can store the bit file in the storage sub-system. Upon request from a circuit designer, the mapping sub-system transmits the bit files to the emulator, and the emulator can use the bit files to structure the FPGAs to emulate the DUT.

If the emulator includes specialized ASICs that include the trace and injection logic, the mapping sub-system can generate a specific structure that connects the specialized ASICs to the DUT. In some embodiments, the mapping sub-system can save the information of the traced/injected signal and where the information is stored on the specialized ASIC.

The run time sub-system controls emulations performed by the emulator. The run time sub-system can cause the emulator to start or stop executing an emulation. Additionally, the run time sub-system can provide input signals and data to the emulator. The input signals can be provided directly to the emulator through the connection or indirectly through other input signal devices. For example, the host system can control an input signal device to provide the input signals to the emulator. The input signal device can be, for example, a test board (directly or through cables), signal generator, another emulator, or another host system.

The results sub-system processes emulation results generated by the emulator. During emulation and/or after completing the emulation, the results sub-system receives emulation results from the emulator generated during the emulation. The emulation results include signals traced during the emulation. Specifically, the emulation results include interface signals traced by the trace and injection logic emulated by each FPGA and can include signals traced by additional logic included in the DUT. Each traced signal can span multiple cycles of the emulation. A traced signal includes multiple states and each state is associated with a time of the emulation. The results sub-system stores the traced signals in the storage sub-system. For each stored signal, the results sub-system can store information indicating which FPGA generated the traced signal.

The debug sub-system allows circuit designers to debug DUT components. After the emulator has emulated a DUT and the results sub-system has received the interface signals traced by the trace and injection logic during the emulation, a circuit designer can request to debug a component of the DUT by re-emulating the component for a specific time period. In a request to debug a component, the circuit designer identifies the component and indicates a time period of the emulation to debug. The circuit designer's request can include a sampling rate that indicates how often states of debugged components should be saved by logic that traces signals.

The debug sub-system identifies one or more FPGAs of the emulator that are emulating the component using the information stored by the mapping sub-system in the storage sub-system. For each identified FPGA, the debug sub-system retrieves, from the storage sub-system, interface signals traced by the trace and injection logic of the FPGA during the time period indicated by the circuit designer. For example, the debug sub-system retrieves states traced by the trace and injection logic that are associated with the time period.

The debug sub-system transmits the retrieved interface signals to the emulator. The debug sub-system instructs the debug sub-system to use the identified FPGAs and for the trace and injection logic of each identified FPGA to inject its respective traced signals into logic of the FPGA to re-emulate the component for the requested time period. The debug sub-system can further transmit the sampling rate provided by the circuit designer to the emulator so that the tracing logic traces states at the proper intervals.

To debug the component, the emulator can use the FPGAs to which the component has been mapped. Additionally, the re-emulation of the component can be performed at any point specified by the circuit designer.

For an identified FPGA, the debug sub-system can transmit instructions to the emulator to load multiple emulator FPGAs with the same configuration of the identified FPGA. The debug sub-system additionally signals the emulator to use the multiple FPGAs in parallel. Each FPGA from the multiple FPGAs is used with a different time window of the interface signals to generate a larger time window in a shorter amount of time. For example, the identified FPGA can require an hour or more to use a certain amount of cycles. However, if multiple FPGAs have the same data and structure of the identified FPGA and each of these FPGAs runs a subset of the cycles, the emulator can require a few minutes for the FPGAs to collectively use all the cycles.

A circuit designer can identify a hierarchy or a list of DUT signals to re-emulate. To enable this, the debug sub-system determines the FPGA needed to emulate the hierarchy or list of signals, retrieves the necessary interface signals, and transmits the retrieved interface signals to the emulator for re-emulation. Thus, a circuit designer can identify any element (e.g., component, device, or signal) of the DUT to debug/re-emulate.

The waveform sub-system generates waveforms using the traced signals. If a circuit designer requests to view a waveform of a signal traced during an emulation run, the host system retrieves the signal from the storage sub-system. The waveform sub-system displays a plot of the signal. For one or more signals, when the signals are received from the emulator, the waveform sub-system can automatically generate the plots of the signals.

FIG. 12 illustrates an example machine of a computer system 1200 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1200 includes a processing device 1202, a main memory 1204 (e.g., read-only memory (ROM), flash memory, dynamic random access memory (DRAM) such as synchronous DRAM (SDRAM), a static memory 1206 (e.g., flash memory, static random access memory (SRAM), etc.), and a data storage device 1218, which communicate with each other via a bus 1130.

Processing device 1202 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. The processing device 1202 may be configured to execute instructions 1126 for performing the operations and steps described herein.

The computer system 1200 may further include a network interface device 1208 to communicate over the network 1120. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), a graphics processing unit 1122, a signal generation device 1216 (e.g., a speaker), graphics processing unit 1122, video processing unit 1128, and audio processing unit 1132.

The data storage device 1218 may include a machine-readable storage medium 1124 (also known as a non-transitory computer-readable medium) on which is stored one or more sets of instructions 1126 or software embodying any one or more of the methodologies or functions described herein. The instructions 1126 may also reside, completely or at least partially, within the main memory 1204 and/or within the processing device 1202 during execution thereof by the computer system 1200, the main memory 1204 and the processing device 1202 also constituting machine-readable storage media.

In some implementations, the instructions 1126 include instructions to implement functionality corresponding to the present disclosure. While the machine-readable storage medium 1124 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1202 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
obtaining a circuit design;
determining, by a processor, a first strongly connected component within the circuit design and generating replica strongly connected components and an output support sub-circuit from the first strongly connected component;
updating the circuit design based on the replica strongly connected components and the output support sub-circuit; and
verifying the updated circuit design by emulating the updated circuit design.

2. The method of claim 1, wherein determining the first strongly connected component within the circuit design and generating the replica strongly connected components and the output support sub-circuit from the first strongly connected component comprises:
determining a feedback vertex set for the first strongly connected component, the feedback vertex set comprising two or more nodes associated with cyclic paths within the first strongly connected component.

3. The method of claim 2, wherein the replica strongly connected components are generated based on the two or more nodes of the feedback vertex set, and wherein a number of the replica strongly connected components corresponds to a number of the two or more nodes of the feedback vertex set.

4. The method of claim 3 further comprising inserting registers within feedback paths of the replica strongly connected components.

5. The method of claim 4 further comprising generating the output support sub-circuit by traversing from outputs of the first strongly connected component to determine primitives of the first strongly connected component that are between the outputs and the two or more nodes of the feedback vertex set or inputs of the first strongly connected component.

6. The method of claim 5 further comprising coupling inputs of the output support sub-circuit to outputs of the replica strongly connected components.

7. The method of claim 6, wherein updating the circuit design based on the replica strongly connected components and the output support sub-circuit comprises inserting the replica strongly connected components and the output support sub-circuit in place of the first strongly connected component within the circuit design.

8. A system comprising:
a memory storing instructions; and
one or more processors, coupled with the memory and to execute the instructions, the instructions when executed cause the one or more processors to:
obtain a circuit design;
determine a first strongly connected component within the circuit design and generating replica strongly connected components and an output support sub-circuit from the first strongly connected component;
update the circuit design based on the replica strongly connected components and the output support sub-circuit; and
verify the updated circuit design by emulating the updated circuit design.

9. The system of claim 8, wherein determining, the first strongly connected component within the circuit design and generating the replica strongly connected components and the output support sub-circuit from the first strongly connected component comprises:
determining a feedback vertex set for the first strongly connected component, the feedback vertex set comprising two or more nodes associated with cyclic paths within the first strongly connected component.

10. The system of claim 9, wherein the replica strongly connected components are generated based on the two or more nodes of the feedback vertex set, and wherein a number of the replica strongly connected components corresponds to a number of the two or more nodes of the feedback vertex set.

11. The system of claim 10, wherein the one or more processors are further caused to insert registers within feedback paths of the replica strongly connected components.

12. The system of claim 11, wherein the one or more processors are further caused to generate the output support sub-circuit by traversing from outputs of the first strongly connected component to determine primitives of the first strongly connected component that are between the outputs and the two or more nodes of the feedback vertex set or inputs of the first strongly connected component.

13. The system of claim 12, wherein the one or more processors are further caused to couple inputs of the output support sub-circuit to outputs of the replica strongly connected components.

14. The system of claim 13, wherein the one or more processors are further caused to update the circuit design based on the replica strongly connected components and the output support sub-circuit comprises inserting the replica strongly connected components and the output support sub-circuit in place of the first strongly connected component within the circuit design.

15. A non-transitory computer readable medium comprising stored instructions, which when executed by one or more processors, cause the one or more processors to:
generating a replica strongly connected components and an output support sub-circuit for a first strongly connected component within a circuit design;
update the circuit design based on the replica strongly connected components and the output support sub-circuit; and
verify the updated circuit design by emulating the updated circuit design.

16. The non-transitory computer readable medium of claim 15, wherein generating the replica strongly connected components and the output support sub-circuit from the first strongly connected component comprises:
determining a feedback vertex set for the first strongly connected component, the feedback vertex set comprising two or more nodes associated with cyclic paths within the first strongly connected component.

17. The non-transitory computer readable medium of claim 16, wherein the replica strongly connected components are generated based on the two or more nodes of the feedback vertex set, wherein a number of the replica strongly connected components corresponds to a number of the two or more nodes of the feedback vertex set, and wherein the one or more processors are further caused to insert registers within feedback paths of the replica strongly connected components.

18. The non-transitory computer readable medium of claim 17, wherein the one or more processors are further caused to generate the output support sub-circuit by traversing from outputs of the first strongly connected component to determine primitives of the first strongly connected component that are between the outputs and the two or more nodes of the feedback vertex set or inputs of the first strongly connected component.

19. The non-transitory computer readable medium of claim 18, wherein the one or more processors are further caused to couple inputs of the output support sub-circuit to outputs of the replica strongly connected components.

20. The non-transitory computer readable medium of claim 19, wherein the one or more processors are further caused to update the circuit design based on the replica strongly connected components and the output support sub-circuit comprises inserting the replica strongly connected components and the output support sub-circuit in place of the first strongly connected component within the circuit design.
